(19) United States
(12) Patent Application Publication
(10) Pub. No.: US 2014/0100704 A1
(43) Pub. Date: Apr. 10, 2014

(54) SYSTEM AND METHOD FOR PROVIDING CLOUD SERVICE SYSTEM FOR POWER SYSTEM

(71) Applicant: LSIS CO., LTD., Anyang-si (KR)

(72) Inventors: Won Seok CHOI, Anyang-si (KR); Jong Ho PARK, Gwangmyeong-si (KR); Yong Hark SHIN, Seoul (KR); Jin LEE, Uiwang-si (KR)

(73) Assignee: LSIS CO., LTD., Anyang-si (KR)

(21) Appl. No.: 14/037,238

(22) Filed: Sep. 25, 2013

(30) Foreign Application Priority Data
Oct. 9, 2012 (KR) 10-2012-0111840

(51) Int. Cl. G05B 15/02

(52) U.S. Cl. CPC G05B 15/02
USPC 700/291

(57) ABSTRACT

A cloud service system and method for a power system are provided. The cloud service system includes: at least one power system; a remote control server configured to receive collected data from the power system and generate and transmit a control signal to the power system; and a cloud server configured to connect the at least one power system to the remote control server through the Internet, store the collected data from the at least one power system, and provide the stored data according to a request from an external terminal.

### CROSS-REFERENCE TO RELATED APPLICATION

Pursuant to 35 U.S.C. §119(a), this application claims the benefit of earlier filing date and right of priority to Korean Application No. 10-2012-0111840, filed on Oct. 9, 2012, the contents of which is incorporated by reference herein in its entirety.

### BACKGROUND OF THE INVENTION

1. Field of the Invention

The present disclosure relates to a system and method for providing a cloud service for a power system.

2. Background of the Invention

In general, a power system is an array of electric installation including a power transmission line, a substation, a distribution line, and the like, that transports and distributes power produced by a generating unit.

FIG. 1 is a view illustrating a configuration connecting a related art power system and control system.

As illustrated in FIG. 1, an existing power system 10 has a closed structure transmitting collected data to a control system 20 in a remote area and receives a corresponding control signal. The power system and control system having the closed structure is not appropriate for a smart grid.

A smart grid, combining an information technology to an existing uni-directional power network including power generation, power transmission, power distribution and sale, refers to an ‘intelligent power network’ allowing a power supplier and a consumer to exchange real-time information bi-directionally, thus optimizing energy efficiency. A power plant, a power transmission and power distribution installation, and a power consumer are connected through an information communication network to allow information to be shared bi-directionally, whereby the power system is integrally driven to be effectively operated as a whole.

However, the existing power system is connected to a control system through direct communication and has a closed configuration in which a connection thereof to the exterior is cut off, and thus, it is difficult to form a structure of a smart grid allowing a power supplier and a consumer to exchange real-time information and generate shared data in both directions.

### SUMMARY OF THE INVENTION

Therefore, an aspect of the detailed description is to provide a system and method for providing a cloud service for a power system to realize a smart grid.

Another aspect of the detailed description is to provide a system and method for providing a cloud service for a power system to increase utilization of the power system by increasing openness of a power system infrastructure.

To achieve these and other advantages and in accordance with the purpose of this specification, as embodied and broadly described herein, a system for providing a cloud service for a power system, includes: at least one power system; a remote control server configured to receive collected data from the power system and generate and transmit a control signal to the power system; and a cloud server configured to connect the at least one power system to the remote control server through the Internet, store the collected data from the at least one power system, and provide the stored data according to a request from an external terminal.

To achieve these and other advantages and in accordance with the purpose of this specification, as embodied and broadly described herein, a method for providing a cloud service for a power system, includes: obtaining collected data continuously or periodically; checking a security level with respect to the obtained data; classifying the obtained data according to a pre-set security level; and transmitting the classified data to a remote control server and a cloud server connected through the Internet, respectively.

In the case of the system and method for providing a cloud service for a power system according to embodiments of the present invention, a period of time required for establishing a system can be shortened by applying a cloud service to an existing power system infrastructure.

Also, in the case of the system and method for providing a cloud service for a power system according to embodiments of the present invention, reliability can be secured through data storage duplication by applying a cloud service to an existing power system infrastructure.

Also, in the case of the system and method for providing a cloud service for a power system according to embodiments of the present invention, since securing system openness is secured by applying a cloud service to an existing power system infrastructure, an access to an external system is facilitated, increasing utilization of the system.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a view illustrating a configuration for connecting a related art power system and a control system.

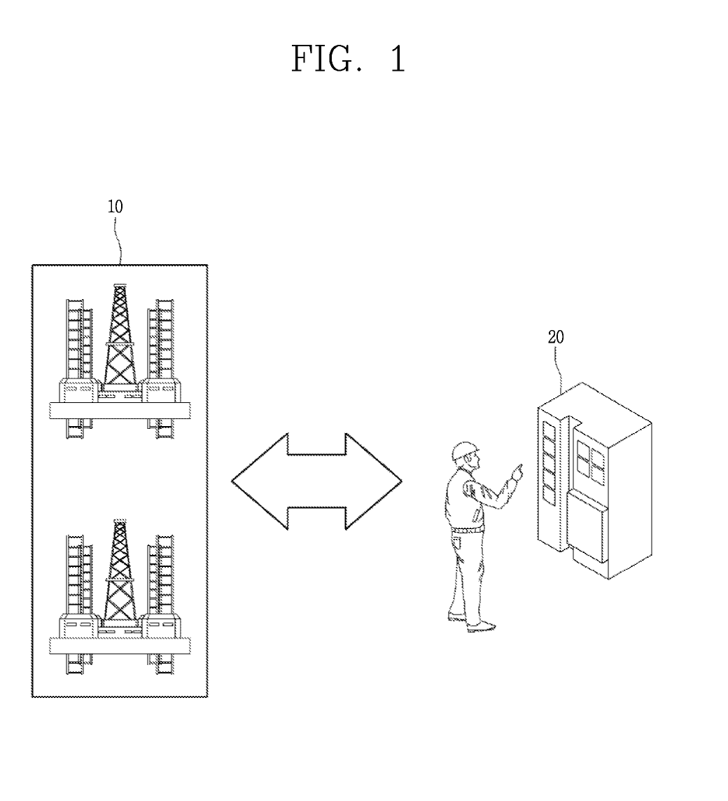

FIG. 2 is a block diagram of a system for providing a cloud service for a power system to which an embodiment of the present invention is applied.

FIG. 3 is a flow chart illustrating a method for providing a cloud service of a power system according to an embodiment of the present invention.

### DETAILED DESCRIPTION OF THE INVENTION

Embodiments of the present invention will be described in detail with reference to the accompanying drawings.

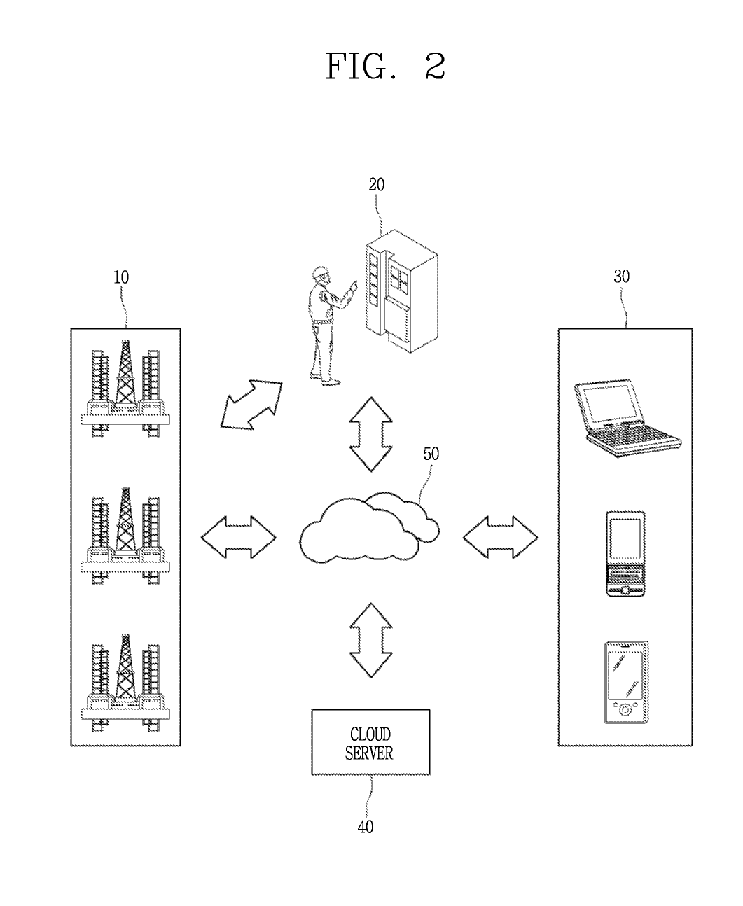

FIG. 2 is a block diagram of a system for providing a cloud service for a power system to which an embodiment of the present invention is applied.

Referring to FIG. 2, a system for providing a cloud service for a power system which an embodiment of the present invention is applied may include at least one power system 10, a remote control server 20, at least one external terminal 30, and a cloud server 40.

The power system 10 serves to produce power and distribute the produced power to a destination. The power system 10 may form data of the produced power and transmit the same to the remote control server 20 and a designated external terminal 30. Also, the power system 10 according to an embodiment of the present invention may transmit the produced power and collected power data to the cloud server 40 connected by a cloud service network 50. In this case, the power system 10 transmits the power data to the remote control server 20 or the cloud server 40 in consideration of a pre-set security/reliability level of the power data or a data rate of the Internet.

The remote control server 20 may obtain the power data collected from the at least one power system 10 and generate a control signal of the corresponding power system. The remote control server 20 according to an embodiment of the present invention is connected to the power system 10, the external terminal 30, and the cloud server 40 through the Internet 50, and backs up data of the power system 10 to the cloud server 40. Also, data of the power system 10 may be classified and stored according to a security/reliability level thereof.

The external terminal 30 may include various types of mobile terminals. The external terminal 30 according to an embodiment of the present invention may access the remote control server 20 or the cloud server 40, and when authentication of the external terminal 30 is completed, the external terminal 30 may receive data stored in the cloud server 40.

The cloud server 40 may be connected to at least one power system 10, at least one remote control server 20, at least one external terminal 30 through the Internet 50. The cloud server 50 may store information or data regarding the power system 10, the remote control server 20, and the external terminal 30.

In addition to data received from the power system 10 according to a pre-set security level or reliability level, the cloud server 40 may store or back up all data of the power system 10 according to request from the remote control server 20.

The cloud server 40 according to an embodiment of the present invention may sense connection of the external terminal 30 thereto and transmit stored or backed-up power data, which has been collected from the power system 10, to the external terminal 30.

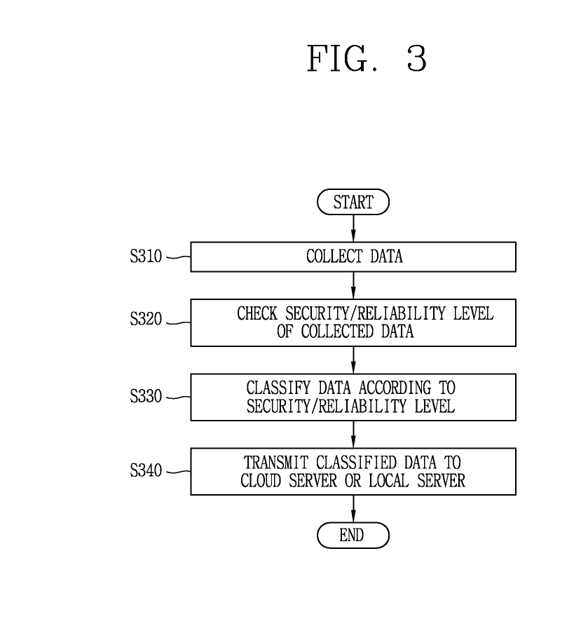

FIG. 3 is a flow chart illustrating a method for using a cloud service of a power system according to an embodiment of the present invention.

Referring to FIG. 3, the power system 10 according to an embodiment of the present invention may obtain power data produced or collected in real time or periodically (S310).

The power system 10 may check a security or reliability level of the obtained data (S320). To check the security or reliability level, the power system 10 may refer to previously classified levels in the remote control server 20 or the power system 10.

The power system 10 may classify data according to the checked security or reliability level of the collected data (S330), and transmit the classified data to the cloud server 40 or the remote control server 20 as a local server (S340), respectively.

When a data request signal from the power system 10 is sensed through the remote control server 20 or the cloud server 40, the external terminal 30 checks information of the corresponding external terminal 30, and when the information is identical to previously stored information regarding the external terminal 30, the external terminal 30 may transmit data stored in the cloud sever 40 to the corresponding terminal.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A system for providing a cloud service for a power system, the system comprising:
at least one power system;
a remote control server configured to receive collected data from the power system and generate and transmit a control signal to the power system; and
a cloud server configured to connect the at least one power system to the remote control server through the Internet, store the collected data from the at least one power system, and provide the stored data according to a request from an external terminal,
wherein the at least one power system checks a security level of the collected data, classifies the collected data according to the security level, and transmit the data to the remote control server or the cloud server.

2. The system of claim 1, wherein the at least one power system checks a data transfer rate of the Internet connected to the remote control server and the cloud server, and sets a destination to which the data is to be transmitted according to the data transfer rate.

3. The system of claim 1, wherein when a communication request signal from an external terminal is sensed, the cloud server provides data stored therein to the external terminal according to a control signal from the remote control server.

4. A method for providing a cloud service for a power system, the method comprising:
obtaining collected data continuously or periodically;
checking a security level with respect to the obtained data;
classifying the obtained data according to a pre-set security level; and
transmitting the classified data to a remote control server and a cloud server connected through the Internet, respectively.

5. The method of claim 4, wherein the collected data is transmitted to the remote control server or the cloud server according to a data transfer rate of the Internet.
